(19) United States
(12) Patent Application Publication
(10) Pub. No.: US 2015/0348446 A1
(43) Pub. Date: Dec. 3, 2015

(54) LABEL ROLL

(71) Applicant: WE'LL CORPORATION, Ishikawa (JP)

(72) Inventor: Norikazu KIYOTOMO, Chuo-ku, Tokyo (JP)

(73) Assignee: WE'LL CORPORATION, Ishikawa (JP)

(21) Appl. No.: 14/652,501

(22) PCT Filed: Oct. 24, 2013
(86) PCT No.: PCT/JP2013/078782

§ 371 Date: Jun. 16, 2015

(30) Foreign Application Priority Data
Dec. 18, 2012 (JP) 2012-275431

(51) Int. Cl. G09F 3/02

(52) U.S. Cl. CPC G09F 3/02; G09F 2003/0222; G09F 2003/023; G09F 2003/0229

(57) ABSTRACT

A label roll is configured by rolling up a band-shaped label set formed by connecting a plurality of labels to be attached to an adherend with part of each label protruding. Each label has abase section having an overcoat layer on its front surface. A self-adhering adhesive section and a non-adhesive section are formed on the base section's back surface. In the band-shaped label set, the front and back surfaces of a plurality of the labels partially overlap. The labels are connected to each other by adhering the overcoat layer of the front surface of the next adjacently disposed label to a predetermined region of the adhesive section formed on the back surface of each label base section; and the surface area of the predetermined region is greater than 50% of the total surface area of the adhesive section formed on the back surface.

### FIELD OF THE INVENTION

The field relates to a label roll, and particularly relates to a label roll that does not use release paper, which is configured by rolling up a band-shaped label set formed by connecting a plurality of product advertisement labels to be attached to products with, for example, part of a label protruding from the product.

### BACKGROUND OF THE INVENTION

No-separator labels, which do not use release paper (a separator), have little waste and contribute to reducing the load on the environment, and are therefore widely used as labels for attaching to products or other adherends. There are various types of no-separator labels. For example, Patent Document 1 proposes a label roll W (see. FIG. 11) which is a band-shaped label set 8 obtained so that a plurality of no-separator labels 1 connected to form a band shape are rolled up into a roll shape around a tubular core 7.

Specifically, the label roll W is formed by rolling up the band-shaped label set 8 into a roll shape, the label set being formed by connecting the no-separator labels (referred to below simply as “labels”) 1 such that they overlap as being staggered one by one, as shown in FIG. 11(a). Each label 1 comprises a label base section 2 having a printed section in which the slogan or the like is printed, an overcoat layer (release layer) 3 formed on the front surface of the label base section 2, and an adhesive section (self-adhesive material layer) 4 formed on the back surface of the label base section 2 (see FIG. 11(b)).

It is also proposed that the label roll W described above is mounted on a labeling machine (label-attaching equipment) and the labels are automatically attached to an adherend. For example, Patent Document 2 proposes label-attaching equipment in which a label roll W such as that described above is mounted, and labels 1 are peeled away from the label roll W and automatically attached to an adherend. This label-attaching equipment comprises a belt conveyor for moving the adherend, a label support section for rotatably supporting the label roll W, and a label-attaching mechanism for drawing out the labels 1 still in band form from the label roll W supported on the label support section, peeling away the labels 1 one by one from this band form, and attaching the labels to the adherend.

In recent years, product advertisement labels to be attached with part of each label protruding from the product have been widely used on products displayed in stores. For example, in the label (partially tacked POP label) disclosed in Patent Document 3, a printed section on which the slogan or the like is printed is formed on the front surface, and formed on the back surface are an adhesive section that can be self-adhered to the product and a non-adhesive section that cannot be self-adhered to the product.

### PRIOR ART DOCUMENTS

### Patent Documents

Patent Document 1 refers to: Japanese Patent No, 3205804.

Patent Document 2 refers to: WO 2010/101101 A1.

Patent Document 3 refers to Utility Model Registration No. 3177283.

### SUMMARY OF THE INVENTION

In one example, a label roll configured by rolling up a band-shaped label set formed by connecting a plurality of labels to be attached to an adherend with part of each label protruding, the label roll comprises:
each of the labels having a label base section and an overcoat layer provided on the front surface of the label base section;
an adhesive section capable of self-adhering to the adherend and a non-adhesive section incapable of self-adhering to the adherend are formed on the back surface of the label base section;
the band-shaped label set being disposed so that the front and back surfaces of a plurality of the labels partially overlap, the labels being connected to each other by causing the overcoat layer of the front surface of the next adjacently disposed label to adhere to a predetermined region of the adhesive section formed on the back surface of each label base section; and the surface area of the predetermined region of the adhesive section being greater than 50% of the total surface area of the adhesive section formed on the back surface.

### BRIEF DESCRIPTION OF THE DRAWINGS

Further features and advantages of the invention will become apparent from reading the following detailed description in conjunction with the following drawings, in which like reference numbers refer to like parts;

FIG. 1 is an external schematic view of the label roll of the first embodiment of the present invention;

FIG. 2 includes schematic views depicting the label constituting a label roll of the first embodiment of the present invention, including FIG. 2A showing a schematic view showing the back surface of the label, and FIG, 2B showing a schematic view showing the label attached to a product;

FIG. 3 includes schematic views depicting a modification of the first embodiment of the present invention, including FIG. 3A showing a schematic view showing a flat surface of a band-shaped label set constituting the label roll, and FIG. 3B showing a schematic view showing part of a cross section of the label roll;

FIG. 4 includes schematic views depicting the state where the self-adhesive paste bulges out from the back surface of the label in the first embodiment of the present invention, including FIG. 4A showing a schematic view showing a cross section of the label, and FIG. 4B showing a schematic view showing the state where the self-adhesive paste has bulged out from the label, and FIG. 4C showing a schematic view for describing the state where the self-adhesive paste bulges out from the label roll of the first embodiment;

FIG. 5 includes schematic views depicting the label roll of the second embodiment of the present invention, including FIG. 5A showing a schematic view showing the flat surface of the band-shaped label set of the second embodiment, and FIG. 5B showing a schematic view showing a cross section of the band-shaped label set of the second embodiment;

FIG. 6 includes schematic views depicting the state where the self-adhesive paste bulges out from the back surface of a label of the second embodiment of the present invention, including FIG. 6A showing a schematic view showing a cross section of the label of the second embodiment, and FIG. 6B showing a schematic view showing the state where the self-adhesive paste bulges out from the back surface of the label of the second embodiment;

FIG. 7 includes schematic views depicting the steps of forming a side-surface coat layer on a label of the second embodiment of the present invention, including FIG. 7A showing a schematic view showing a printing block being moved toward the edge of a label, FIG. 7B showing a schematic view showing the printing block being pressed into the edge of the label, and FIG. 7C showing a schematic view showing the printing block being separated from the label;

FIG. 8 includes schematic views depicting the label roll of the third embodiment of the present invention, including FIG. 8A showing a schematic view showing the flat surface of the band-shaped label set of the third embodiment, FIG. 8B showing a schematic view showing a cross section of the band-shaped label set of the second embodiment, and FIG. 8C showing a schematic view showing a modification of the third embodiment;

FIG. 9 includes schematic views showing a modification of the label roil of the fourth embodiment of the present invention, including FIG. 9A showing a schematic view showing the back surface of a label of the fourth embodiment, and FIG. 9B showing a schematic view showing a cross section of the band-shaped label set of the fourth embodiment;

FIG. 10 is a schematic view for describing a modification of the fourth embodiment of the present invention;

FIG. 11 includes schematic views depicting a label roll configured from labels that do not use the release paper of the prior art, including FIG. 11A showing a schematic view showing an external view of the label roll, and FIG. 11B showing a schematic view showing the interconnection of labels constituting the label roll; and

FIG. 12 is a schematic view of the prior art showing labels being drawn out from the label roll of the prior art while still in a band shape.

### DETAILED DESCRIPTION

The examples and drawings provided in the detailed description are merely examples, and should not be used to limit the scope of the claims in any claim construction or interpretation.

### Problems to be Solved by the Invention

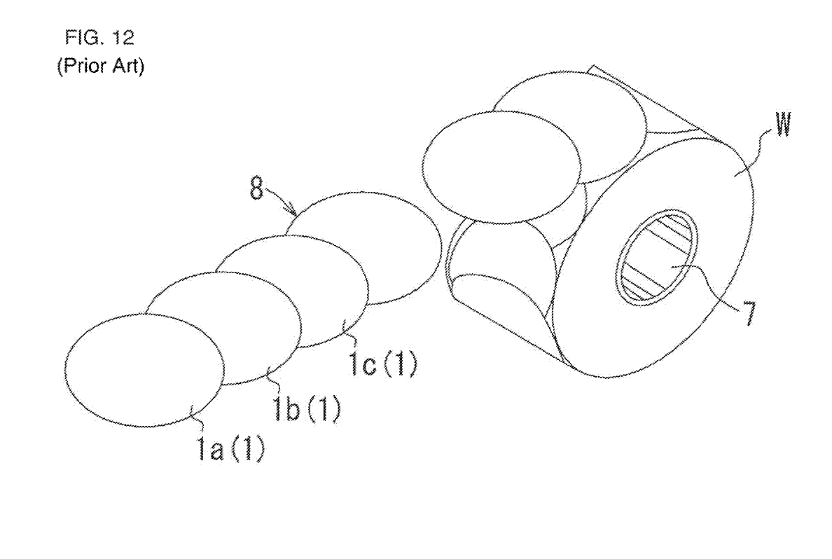

However, the label roll W of the prior art described above has a technical problem in that while the tip end side thereof is pulled and the labels 1 are drawn out in a band shape (the band-shaped label set 8), the band-shaped label set 8 is sometimes cut off in the middle, as shown in FIG. 12. Specifically, sometimes the labels 1 cannot be continuously drawn out in the label roll W. Therefore, in label-attaching equipment such as that described above, the labels 1 are frequently cut off when the label roll W is mounted and used, causing situations in which the automatic attaching process is frequently interrupted.

In view of this, upon investigating the cause of this problem, the inventors of the present application have discovered that the main cause of the labels not being continuously drawn out from the label roll is that the bonding force of one label of the label roll with the next label adjacent and adhered to this first label (the label bonding force between labels of the same layer) is less than the bonding force with a lower-layer label disposed one layer lower and adhered to the back surface of the first label (the label bonding force between labels of a higher and lower layer). Specifically, when the bonding force between labels of the same layer is less than the bonding force between labels of a higher and lower layer and the tip end side of the label roll W (the tip end side label 1) is pulled, the next label 1 connected to the tip end side label 1 remains without peeling off of the lower-layer band-shaped label set 8B and separates from the tip end side label 1 (the labels 1 cannot be continuously drawn out of the label roll W).

Therefore, if the label roll W is provided with a configuration that strengthens the bonding force between labels 1 of the same layer above the bonding force between labels 1 of a higher and lower layer, the band-shaped label set 8 can be prevented from being cut off in the middle while the labels 1 are being drawn out, and the labels 1 can be continuously drawn out When a label roll is provided in which the band-shaped label set 8 is prevented from being cut off in the middle, the operating efficiency of a label-attaching process using label-attaching equipment is improved.

However, there are currently no known label rolls having a configuration that strengthens the bonding force between labels of the same layer above the bonding force between labels of a higher and lower layer. It would also be convenient to be able to fit label-attaching equipment with the “product advertisement label to be attached to a product with part of the label protruding from the product” disclosed in Patent Document 3, and to automatically attach labels to products. However, there are currently no “product advertisement labels” such as those described above that form a roll shape by being staggered to overlap one by one, and no automatic attachment of “product advertisement labels” is performed using label-attaching equipment such as that described above.

The present invention was devised in view of the technical problems described above, and an object thereof is to enable labels to be continuously drawn out in a label roll formed by connecting a plurality of labels attached to an adherend with part of each label protruding.

### Means Used to Solve the Above-Mentioned Problems

The present invention for solving the technical problems described above is a label roll configured by rolling up a band-shaped label set formed by connecting a plurality of labels that are attached to an adherend with part of each label protruding, the label roll characterized in that: each of the labels has a label base section and an overcoat layer provided on the front surface of the label base section; an adhesive section capable of self-adhering to the adherend and a non-adhesive section incapable of self-adhering to the adherend are formed on the back surface of the label base section; the band-shaped label set is disposed so that the front and back surfaces of a plurality of the labels partially overlap, the labels being connected to each other by causing the overcoat layer of the front surface of the next adjacently disposed label to adhere to a predetermined region of the adhesive section formed on the back surface of each label base section; and the surface area of the predetermined region of the adhesive section is greater than 50% of the total surface area of the adhesive section formed on the back surface.

Thus, the label roll of the present invention is configured by forming a band-shaped label set in which labels are connected to each other by adhering a predetermined region of an adhesive section of the back surface of a label to an overcoat layer of the front surface of the next label disposed adjacent thereto, and rolling up this band-shaped label set into a roll shape; therefore, a label roll that does not use release paper is obtained. In the configuration described above, the band-shaped label set is prevented from being cut off in the middle while the head label of the label roll is pulled and the band-shaped label set is being drawn out, and the work of attaching labels is made easier. Specifically, in the present invention, because the band-shaped label set is prevented from being cut off in the middle, the label roll described above can be mounted on a labeling machine (label-attaching equipment) and labels can be automatically attached to products. The reasons as to why the band-shaped label set is prevented from being cut off in the middle are shown below.

As described above, when the “bonding force F1 between adjacent adhered labels of the same layer” is less than the “bonding force F2 between labels of an upper and lower layer” in the label roll, the band-shaped label set is cut off in the middle while the band-shaped label set is being pulled. The relationship of magnitude between the “bonding force F1” and the “bonding force F2” corresponds to the relationship of magnitude between the “surface area of the adhesive region S1 between labels of the same layer” and the “surface area of the adhesive region S2 between labels 1 of an upper and lower layer.” Specifically, if the “surface area of the adhesive region S1” is greater than the “surface area of the adhesive region S2,” the relationship is “bonding force F1>bonding force F2,” and if the “surface area of the adhesive region S1” is less than the “surface area of the adhesive region S2,” the relationship is “bonding force F1<bonding force F2.” Therefore, in the present invention, adjacent labels of the same layer adhere to each other so that the surface area of the adhesive region S1 with the next label of the same layer adhered to the back surface of the label is greater than 50% of the total surface area of the adhesive section formed on the back surface. With this configuration, even in a case where all of the adhesive section of the back surface outside of the “adhesive region S1 with the next label of the same layer” adheres to a lower-layer label, the “surface area of the adhesive region S1” is greater than the “surface area of the adhesive region S2” and the prerequisite “bonding force F1>bonding force F2” is satisfied.

Preferably, adjacent labels are connected to each other so that the surface area of the predetermined region of the adhesive section is 80% or less of the total surface area of the adhesive section formed on the back surface. With this configuration (i.e., the surface area of the predetermined region being 50 to 80% of the total surface area of the adhesive section formed on the back surface), in addition to the band-shaped label set being prevented from being cut off in the middle, the label-attaching equipment is guaranteed to have a “peeling margin” for peeling one label at a time from the label roll.

Preferably, the label has a side-surface coat layer formed in a side-surface part of the region where the adhesive section is formed in the aforementioned label, at least in a location disposed in the adhesive section of the back surface of a front label adjacent and adhering to the aforementioned label.

Thus, in the present invention, because the side-surface coat layer is provided in a side-surface part of the label, a self-adhesive paste that forms the adhesive section of the back surface of the label is covered by the side-surface coat layer even in a case where the self-adhesive paste bulges out of the outer peripheral edge from the back surface. The present invention thereby prevents adjacent labels from being pasted together due to the effect of the self-adhesive paste bulging out of the outer peripheral edge from the back surface of the label, and as a result, situations are prevented in which the label becomes difficult to peel away from the label roll. Therefore, when the label roll of the present invention is used while mounted on label-attaching equipment, there are fewer instances of the label failing to separate from the label roll, and the yield rate of the process of automatically attaching labels to an adherend can be improved. The reason the side-surface coat layer is formed on part of the side-surface part of the label is as follows. That is, “adjacent labels are pasted together” by the self-adhesive paste bulging out from the back surface of the labels. This is caused by the self-adhesive paste bulging out in the portion (part of the side-surface part) disposed on the back surface of the adjacent connected front label.

Preferably, the side-surface coat layer is formed over the entire side-surface part of the region where the adhesive section is formed. If the side-surface coat layer is thus formed over the entire side-surface part of the region where the adhesive section of the side-surface part of the label is formed, situations in which the self-adhesive paste bulges out from the side-surface part of the label roll are prevented, and as a result, adhesion of waste and dirt to the side-surface part of the label roll is prevented.

Preferably, the side-surface coat layer is formed from the same material as the overcoat layer. Thus, because the side-surface coat layer can be formed from a UV varnish, an aqueous varnish, or another material used to form the overcoat layer (because there is no need to procure any special material), production costs can be suppressed.

Preferably, the overcoat layer has first and second overcoat sections having different surface roughness; the first overcoat section, which has greater surface roughness than the second overcoat section, is formed in a first contact region where labels of the same layer come in contact with each other; and the second overcoat section is formed in a second contact region where labels of an upper and lower layer come in contact with each other. Preferably, the first and second overcoat sections are configured from an overcoat agent of the same material selected from a UV varnish, an aqueous varnish, and a silicone release agent; the first overcoat section is formed from a single coating of the overcoat agent; and the second overcoat section is formed from two coatings of the overcoat agent.

Thus, in the present invention, first and second overcoat sections having different surface roughness are provided on the overcoat layer of the front surface of the label. The first overcoat section, which has greater surface roughness than the second overcoat section, is disposed in the first contact region where labels in the same layer come in contact with each other. The second overcoat section is disposed in the second contact region where labels of an upper and lower layer come in contact with each other. Adhered labels of an upper and lower layer thereby separate more readily (peel away more readily) than adhered labels of the same layer when the labels are drawn out. Specifically, in the label roll of the present invention, the bonding force between adhered labels of the same layer can be made stronger than the bonding force between labels of an upper and lower layer, in comparison with the label roll of the prior art. As a result, the labels are prevented from being cut off while the tip end of the label roll is pulled and the labels are being drawn out from the label roll while remaining in a band shape.

### Effect of the Invention

With the configuration of the present invention, a label roll formed by connecting a plurality of labels attached to an adherend with part of each label protruding, wherein the labels can be drawn out continuously is provided.

### BEST MODE FOR CARRYING OUT THE INVENTION

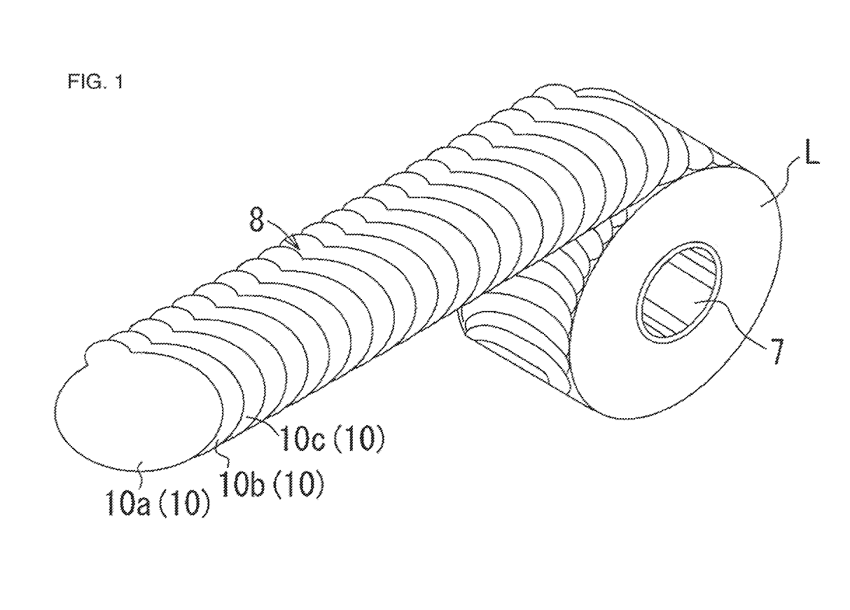

Label rolls of embodiments of the present invention are described below using drawings. The label roll L of the present embodiment is formed by connecting a plurality of product advertisement no-separator labels (“attention labels”) 10, each attached to a product with part of the label 10 protruding from the product (the adherend), and the configuration of the label roll contributes to reducing waste because release paper is not used. First, the label roll of the first embodiment of the present invention is described using FIGS. 1 to 3. In the descriptions of the embodiments of the present invention, configurations identical or equivalent to those of the prior art described above are denoted by the same symbols. The symbol 8A in the drawings indicates a higher-layer band-shaped label set 8A, and the symbol 8B indicates a lower-layer band-shaped label set.

The label roll L of the first embodiment is configured by disposing a plurality of labels 10 so that the front and back surfaces partially overlap, forming a band-shaped label set 8 in which labels 10 are connected to each other by adhering an overcoat layer 3 of the front surfaces of the labels 10 to adhesive sections 4a of the back surfaces of adjacently disposed labels 10, and rolling up this formed band-shaped label set 8 into a roll shape around: a core 7.

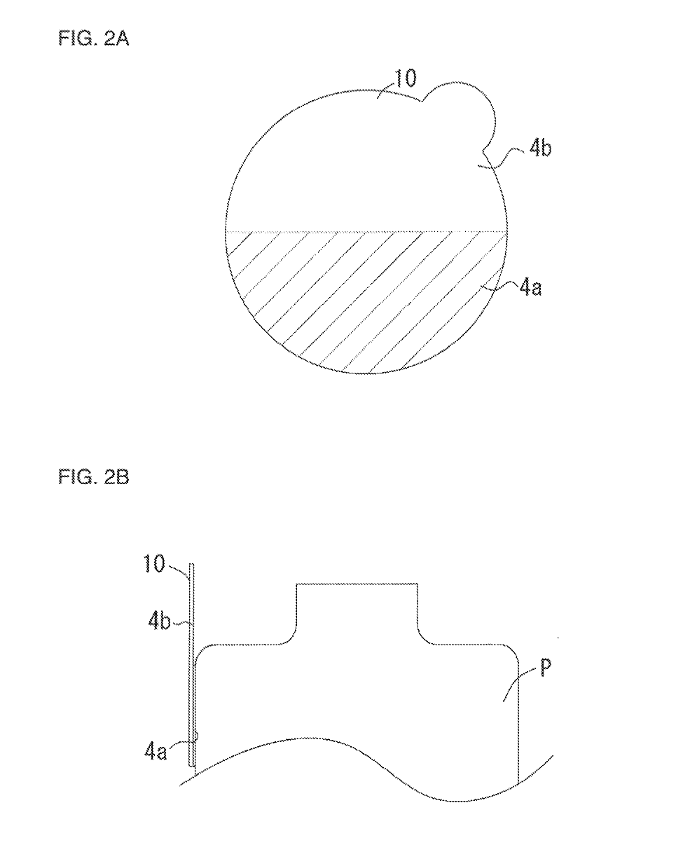

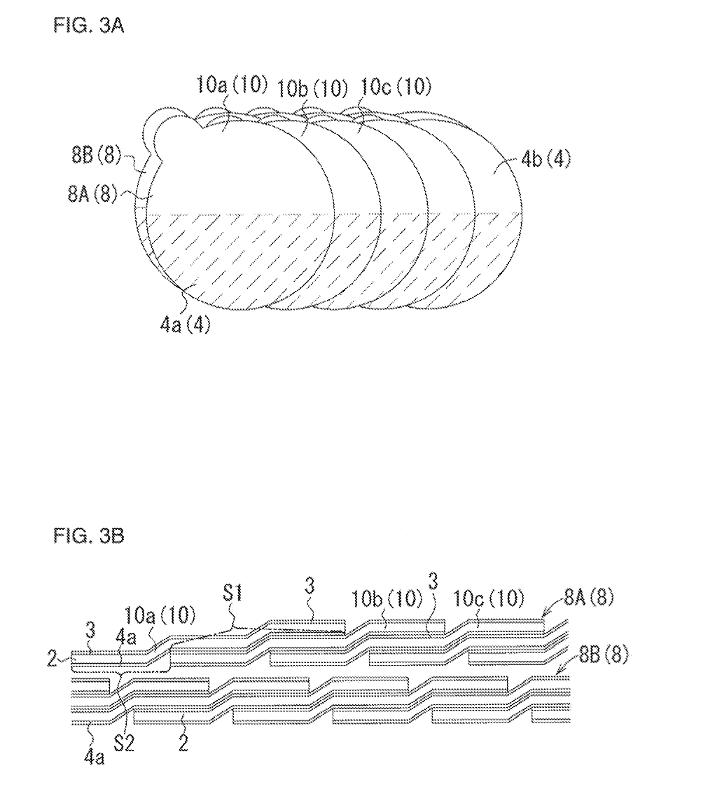

Specifically, each label 10 constituting the label roll L comprises a label base section 2 having a printed section in which the slogan or the like is printed, and an overcoat layer 3 provided on the front surface of the label base section 2 (see FIG. 3(b)). On the back surface side of the label base section 2, the bottom end side is an adhesive section 4a capable of adhering to the product, and the top end side is a non-adhesive section 4b incapable of self-adhering to the product (see FIGS. 2 and 3(a)). The label 10 is used with a part thereof (the non-adhesive section 4b) protruding and the adhesive section 4a self-adhered to the product (adherend) P, as shown in FIG. 2(b).

The aforementioned overcoat layer 3 has both a function of protecting the printed section of the label 10, and the function of making the other label 10 adhered to the front surface of the label 10 easy to peel off. The printed section may be formed on the front surface of the label base section 2, or it may be formed on the back surface of the label base section 2. For example, when the label base section 2 is a transparent film or the like, the printed section is visible from the front surface of the label 10 whether the printed section is formed on the front surface of the label base section 2 or the back surface of the label base section 2.

The label base section 2 is formed from, for example, a polyester film (PET (polyethylene terephthalate)) having a thickness dimension of “30 to 80 μm,” a polypropylene film having a thickness dimension of “50 to 90 μm,” synthetic paper having a thickness dimension of “40 to 80 μm,” or the like. The overcoat layer 3 is formed on the front surface of the label base section 2 by forming a coating of an overcoat agent. This overcoat agent can be, for example, a UV varnish, an aqueous varnish, or the like. The thickness dimension of the overcoat layer 3 is formed to, for example, “1 to 2 μm.”

The adhesive section 4a and the non-adhesive section 4b on the back surface side of the label base section 2 can be formed by, for example, the following method.

An exemplary method of forming an adhesive section and a non-adhesive section on a back surface side of a label base section is described as follows. Specifically, first, the entire back surface of the label base section 2 is coated with a rubber hot melt, a UV-curing acrylic hot melt, or the like, and a tacky surface is formed on the entire back surface of the label base section 2. Next, a detackifying treatment is performed for forming a coating of a varnish, resin, or the like to form a non-adhesive thin film on the top end region of the tacky surface formed on the entire back surface of the label base section 2, and the tacky surface of the top end region is made to be non-self-adhesive. The detackified top end region becomes the non-adhesive section 4b, and the non-detackified bottom end region of the back surface becomes the adhesive section 4a. Through a method of coating only the region of the back surface of the label base section 2 that will become the adhesive section 4a with a rubber hot melt, a UV-curing acrylic hot melt, or the like, rather than performing the detackifying treatment, the adhesive section 4a and the non-adhesive section 4b may be formed on the back surface side of the label base section 2. The thickness dimension of the adhesive section 4 is formed to, for example, “15 to 20 μm.”

In the first embodiment, the adhesive section 4a of the back surface of the label base section 2 is formed on the bottom end side of the label base section 2, but is not limited as such. The position where the adhesive section 4a is formed is set as appropriate in accordance with the application of the label 10. The size of the adhesive section 4a is also set as appropriate in accordance with the application of the label 10. For example, the adhesive section 4a is formed to a size of about “20% to 50%” of the entire back surface of the label base section 2.

The band-shaped label set 8 is formed by sequentially attaching the tip end side of the overcoat layer 3 formed on the front surface of a second label 10b (the next label after a first label 10a) to a predetermined region on the rear end side of the adhesive section 4a formed on the back surface of a first label 10a, and then attaching the tip end side of the overcoat layer 3 formed on the front surface of a third label 10c (the next label after the second label 10b) to a predetermined region on the rear end side of the adhesive section 4a formed on the back surface of the second label lob, as shown in FIG. 3(b). In each of the labels 10, the overlapping portion between the adhesive section 4a formed on the back surface and the overcoat layer 3 of the next label 10 is an adhesive region S1 between labels 10 of the same layer.

In the first embodiment, adjacent labels 10 are connected so that in all labels 10 constituting the higher-layer band-shaped label set 8A, the surface area of the adhesive region S1 with the next label 10 in the same layer adhered to the back surface is greater than the surface area of the adhesive region S2 with the band-shaped label set 8B disposed in the next layer down. For the labels 10 constituting the band-shaped label set 8A to satisfy the relationship “adhesive region S1 surface area>adhesive region S2 surface area,” the prerequisite is at least that the surface area of the adhesive region S1 with the next label 10 in the same layer adhered to the back surface of the label 10 is greater than 50% of the entire surface area of the adhesive section 4a formed on the back surface.

In the label roll L with the configuration described above, the “bonding force F1 between adjacent and adhered labels 10 of the same layer” is greater than the “bonding force F2 between labels 10 of a higher and lower layer.” As a result, while the head label 10 of the label roll L is pulled and the band-shaped label set 8 is being drawn out, the band-shaped label set 8 is prevented from being cut off in the middle. Therefore, in the first embodiment, it is possible to fit a labeling machine (label-attaching equipment) with the label roll L described above and to automatically attach labels to products P. Specifically, in the first embodiment, product advertisement labels (attention labels) 10 to be attached to products with part of the label protruding from the product can be automatically attached, and the operation of attaching the labels (attention labels) 10 is made more efficient.

Specifically, the relationship of magnitude between the “bonding force F1” and the “bonding force F2” is correlated with the relationship of magnitude between the “surface area of the adhesive region S1 between labels 10 of the same layer” and the “surface area of the adhesive region S2 between labels 10 of an upper and lower layer.” Specifically, if the “surface area of the adhesive region S1” is the same as the “surface area of the adhesive region S2,” then “bonding force F1=bonding force F2.” If the “surface area of the adhesive region S1” is greater than the “surface area of the adhesive region S2,” then “bonding force F1>bonding force F2,” and if the “surface area of the adhesive region S1” is less than the “surface area of the adhesive region S2,” then “bonding force F1<bonding force F2.” Therefore, in the present embodiment, the labels 10 are connected so that the surface area of the adhesive region S1 of a label 10 with the next label 10 of the same layer adhered to the back surface is greater than 50% of the entire surface area of the adhesive section 4a formed on the back surface. With such a configuration, even in a case where the entire region of the adhesive section 4a of the back surface of the label 10 excluding the “adhesive region S1 with the next label of the same layer” adheres to a label 10 of the lower layer, the “surface area of the adhesive region S1” is greater than the “surface area of the adhesive region S2” and the prerequisite “bonding force F1>bonding force F2” is satisfied.

Adjacent labels 10 are preferably connected to each other so that the surface area of the adhesive region S1 of the label 10 with the next label 10 of the same layer adhered to the back surface is 80% or less of the entire surface area of the adhesive section 4a formed on the back surface of the label 10. Due to the configuration being as such (specifically, due to the surface area of the adhesive region S1 being 50 to 80% of the entire surface area of the adhesive section 4a formed on the back surface), in addition to the band-shaped label set 8 being prevented from cutting off in the middle, the label-attaching equipment is guaranteed to have a “peeling margin” for peeling one label 10 at a time from the label roll.

Furthermore, in the configuration of the first embodiment, the amount of self-adhesive paste bulging out of the outer peripheral edge of the label 10 from the back surface of the label 10 (self-adhesive paste forming the adhesive section 4a) can be reduced in comparison with the prior art shown in FIG. 12. Specifically, in the first embodiment, because the amount of self-adhesive paste bulging out of the outer peripheral edge of the label 10 is reduced, tacking between adjacent labels 10 caused by the self-adhesive paste is prevented. As a result, in the first embodiment, situations in which the label 10 becomes difficult to peel away from the label roll L are prevented.

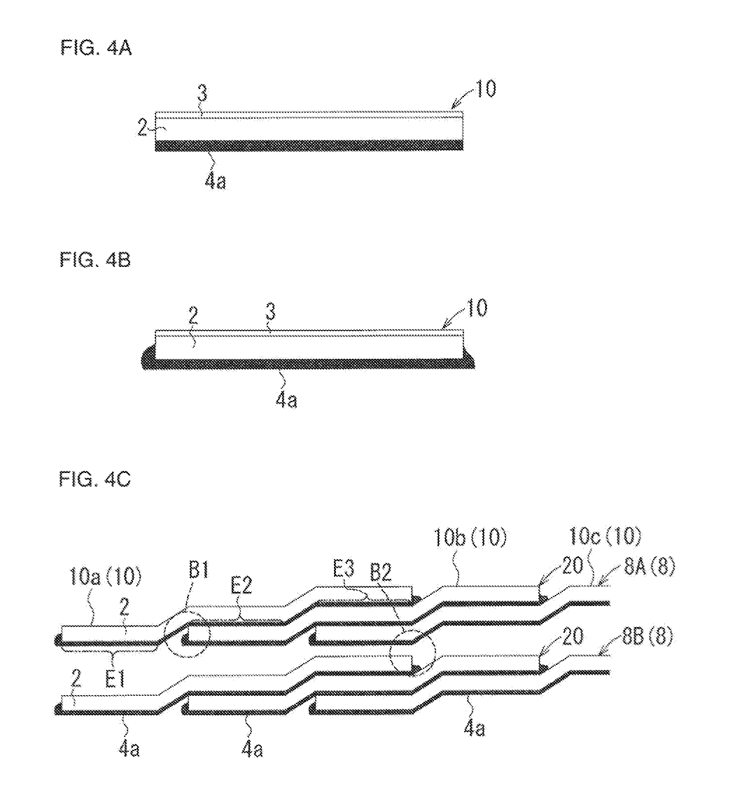

The following is a description, made with reference to FIG. 4, of the effect of the self-adhesive paste bulging out of the outer peripheral edge of the label 10. FIG. 4 includes schematic views depicting the state where the self-adhesive paste bulges out from the back surface of the label in the first embodiment of the present invention, (a) being a schematic view showing a cross section of the bottom end side of the label, (b) being a schematic view showing the state where the self-adhesive paste has bulged out from the label, and (c) being a schematic view for describing the state where the self-adhesive paste bulges out from the label roll of the first embodiment.

The band-shaped label set 8 constituting the label roll L is rolled up into a roll shape under a predetermined amount of tension. Therefore, the band-shaped label set 8 is under pressure force from a band-shaped label set 8 disposed in the higher layer, and is also under reactive force from a band-shaped label set 8 disposed in the lower layer (reactive force against said pressure force). Specifically, each label 10 constituting the label roll L is in a state of being sandwiched with a predetermined pressure between labels 10 disposed in the higher and lower layers. As a result, in each label 10 constituting the label roll L, the self-adhesive paste that forms the adhesive section 4a of the back surface changes over time due to the effect of the predetermined pressure, and situations occur in which the self-adhesive paste bulges out of the outer peripheral edge from the back surface of the label 10 (the change from FIG. 4A to FIG. 4B).

In the example of the first embodiment (the example shown in FIG. 4(c)), two labels 10b and 10c are made to overlap the back surface of a label 10a, and two step parts are formed in each label 10. The adhesive section 4a of the back surface of each label 10 is also divided into a plurality of horizontal regions (three horizontal regions E1, E2, E3) by the step parts. When adjacent labels 10 adhere to each other so that the surface area of the adhesive region S1 is greater than “50% of the entire surface area SA of the adhesive section 4a,” the horizontal regions E1, E2, E3 formed on the back surface of the label 10a are all less than 50% of the entire surface area SA of the adhesive section 4a.

Therefore, due to the surface area of the adhesive region S1 described above being greater than “50% of the entire surface area SA of the adhesive section 4a,” not only is the amount of self-adhesive paste bulging out of the outer peripheral edge of the front end side of the label 10 reduced, but the amount of self-adhesive paste bulging out of the outer peripheral edge of the rear end side of the label 10 is reduced as well. As a result, in the first embodiment, in addition to tacking between adjacent labels 10 caused by the self-adhesive paste being prevented (see symbol B1), tacking between labels 10 of an upper and lower layer caused by the self-adhesive paste is prevented as well (see symbol B2). Therefore, in the first embodiment, situations in which the label 10 becomes difficult to peel away from the label roll L are prevented. Also prevented in the first embodiment are instances in which the label 10 is cut off in the middle. These instances are caused by the self-adhesive paste bulging out from the back surface of the label 10.

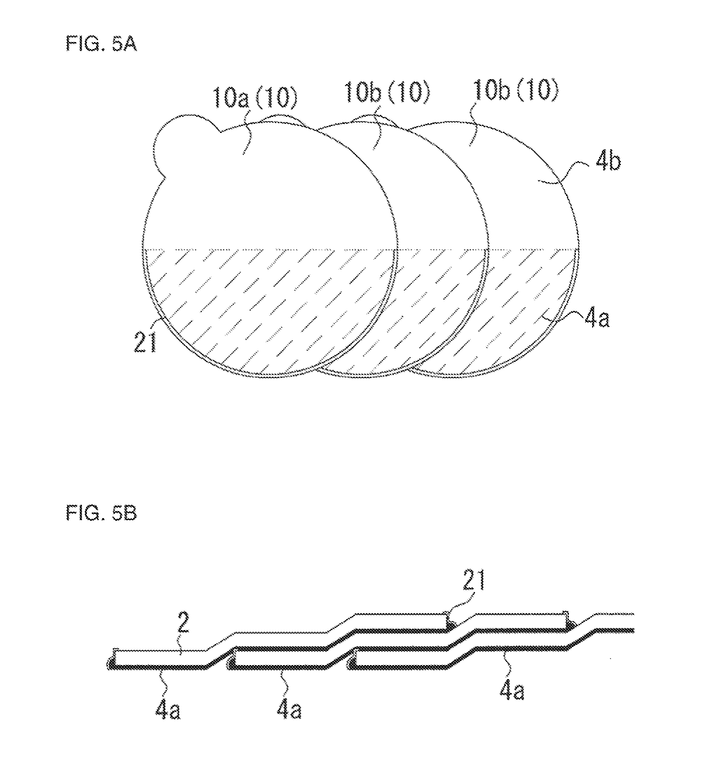

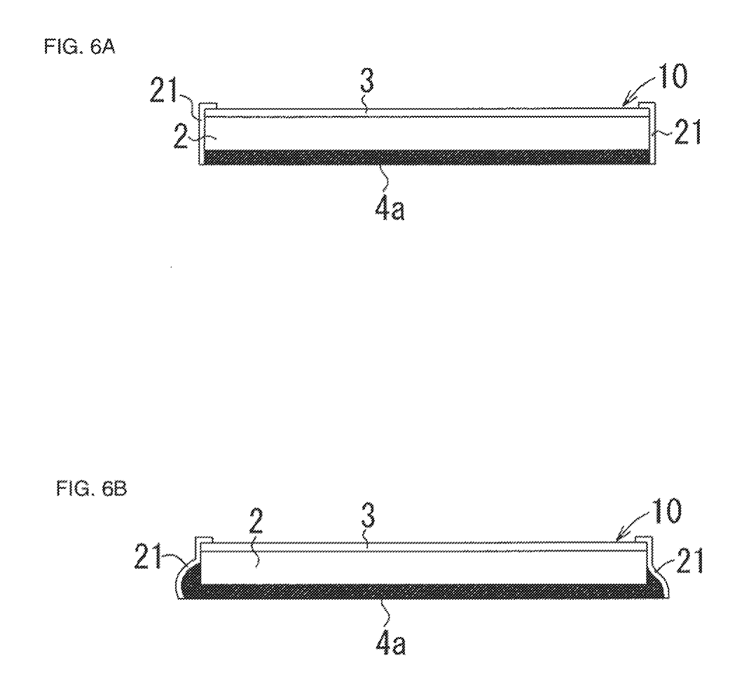

Next, FIGS. 5 and 6 are used to describe the second embodiment of the present invention. The second embodiment adds the configuration of a side-surface coat layer to the configuration of the label roll L of the first embodiment described above. Therefore, portions different from the first embodiment are described in detail below, while descriptions of the same configurations are simplified. In the description of the second embodiment, configurations similar to and equivalent to those of the first embodiment use the same symbols for the sake of convenience in the description.

In the second embodiment, a side-surface coat layer 21, formed by applying a coating (or forming a coating) of an overcoat agent (a release agent) of UV varnish, aqueous varnish, or the like, is provided in the side-surface part of the region where the adhesive section 4a is formed in the side-surface part of the label 10.

Specifically, in the label 10, a side-surface coat layer 21, formed by applying a coating (or forming a coating) of an overcoat agent, is provided over the entire side-surface part (the entire periphery) of the region on which the adhesive section 4a is formed, as shown in FIG. 5A, for example. This side-surface coat layer 21 extends from the bottom end toward the top end of the side-surface part of the label 10, and preferably also further extends from the top end of the side-surface part to the front-surface-edge part of the label 10. The side-surface coat layer 21 is formed from the same material as the overcoat layer 3. Thus, production costs are kept low because the same material used to form the overcoat layer 3 is used as is to form the side-surface coat layer 21.

In the configuration described above, even in a case where the self-adhesive paste forming the adhesive section 4a of the back surface of the label 10 has bulged out in the outer peripheral edge from the back surface of the label 10, the side-surface coat layer 21 formed in the side-surface part firmly adheres to the bulging self-adhesive paste and deforms, and the bulging self-adhesive paste is covered, as shown in FIGS. 6A and 6B. Therefore, even in a case where the self-adhesive paste forming the adhesive section 4a on the back surface of the label 10 bulges out in the outer peripheral edge from the back surface, the side-surface coat layer 21 covering the self-adhesive paste functions as a release layer for the adhesive section 4a of the upper-layer label 20. The self-adhesive paste that bulges out in the outer peripheral edge from the back surface of the label 10 is thereby prevented from tacking with the adhesive section 4a of the adjacent adhered label 10. Specifically, in the second embodiment, the main cause of the increased bonding force between adjacent labels 10 is eliminated, and as a result, situations are prevented in which the labels 10 become difficult to peel away when the labels 10 are drawn out from the label roll L.

In the second embodiment, because the side-surface coat layer 21 is formed over the entire side-surface part of the label 10, in addition to preventing tacking between adjacent labels 10 caused by the effect of the self-adhesive paste, also prevented is tacking between labels 10 of an upper and lower layer caused by the effect of the bulging self-adhesive paste. As a result, also prevented are “situations in which the band-shaped label set 8 is cut off in the middle when a label 10 is drawn out while remaining in a band shape,” which are caused by the self-adhesive paste bulging out from the back surface of the label 10. In the second embodiment, because the side-surface coat layer 21 is formed over the entire side-surface part of the region where the adhesive section 4a is formed in the side-surface part of the label 10, situations are prevented in which the self-adhesive paste bulges out from the side-surface part of the label roll L, and as a result, adhesion of waste and dirt to the side-surface part of the label roll L is prevented.

In the second embodiment, in the side-surface part of the region where the adhesive section 4a of the label 10 is formed, the side-surface coat layer 21 may be formed only on the portion disposed on the back surface of the adjacent connected label 10 in front,

An exemplary reason for such a configuration is that the self-adhesive paste between adjacent disposed labels 10 is made up of the self-adhesive paste bulging in that portion (part of the side-surface part) of the side-surface part of the label 10 which is disposed on the back surface of the adjacent connected label 10 in front. This configuration also prevents tacking between adjacent labels 10 caused by the effect of the self-adhesive paste bulging out in the outer peripheral edge from the back surfaces of the labels 10, and as a result, situations in which the labels 10 become more difficult to peel away from the label roll L are prevented.

The side-surface coat layer 21 of the second embodiment can be formed by, for example, a relief printing system using a printing block for relief printing and liquid ink (a liquid overcoat agent in the present embodiment).

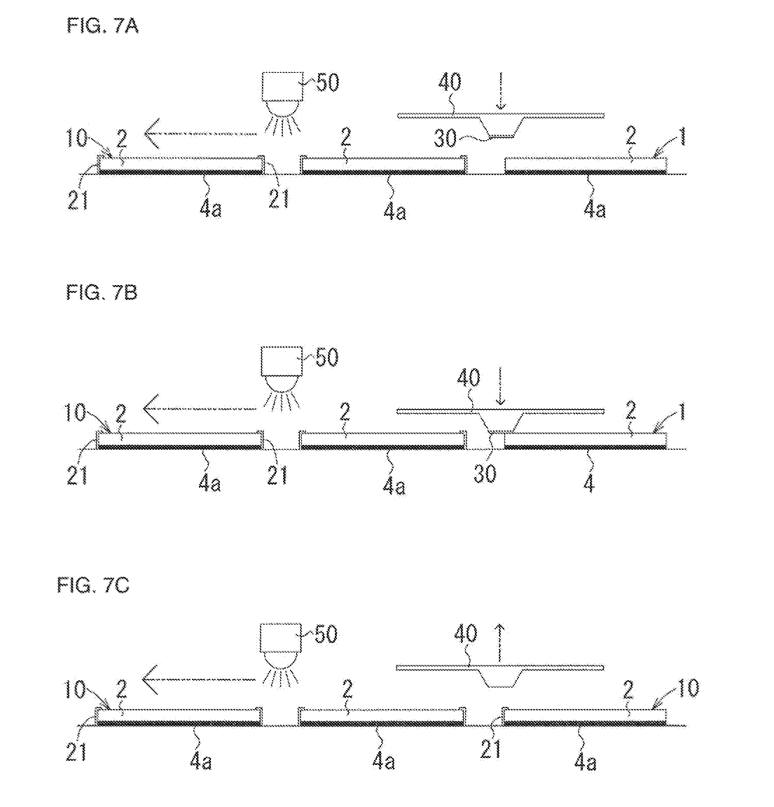

FIG. 7 is used to describe the method of forming the side-surface coat layer 21 by means of a relief printing system. FIG. 7 includes schematic views depicting the steps of forming a side-surface coat layer on the label of the second embodiment of the present invention, FIG. 7A showing a schematic view showing a state in which the printing block is moving toward the edge of a label, FIG. 7B showing a schematic view showing a state in which the printing block is pushed into the edge of the label, and FIG. 7C showing a schematic view showing a state in which the printing block is separating from the label.

The symbol 40 in the drawings indicates a printing block formed from rubber, a resin, or another elastic material, and this printing block 40 has a coated surface of ink formed to about “3 to 5 mm.” The symbol 30 indicates a liquid overcoat agent. The symbol 50 indicates UV radiation equipment for radiating UV rays. The adhesive sections 4a are formed on the bottom-end-side regions of the back surfaces of the label base sections 2, and the overcoat layers 3 are formed on the front surfaces (the overcoat layers 3 are omitted from the drawings for the sake of convenience in the description). In the drawing, the symbol 1 indicates a label before a side-surface coat layer 21 is formed, and the symbol 10 indicates a label on which a side-surface coat layer 21 has been formed.

In the second embodiment, in a first step of forming the side-surface coat layer 21, label printing, outline cutting, and skimming (skimming for removing unneeded portions of the periphery) are performed. Specifically, on a label 1 that has undergone label printing, outline cutting, and skimming, a printing block 40 coated with a liquid overcoat agent (a UV silicone agent or the like) 30 is disposed in a position of being spread over the front surface edge of the label 1 (the front surface edge corresponding to the region where the adhesive section 4a is formed) and the outer side region of the front surface edge, and this printing block 40 is pressed into the edge of the label 1 (see FIGS. 7(a) and (b)). The printing block 40 is then separated from the label 1 (see FIG. 7C). A coating of the overcoat agent 30 is thereby formed on the side-surface part of the label 10. The coating of the overcoat agent 30 is irradiated with UV rays by the UV radiation equipment 50, and the coating of the overcoat agent is cured. The overcoat layer 21 is thereby formed on the side-surface part of the label 10. The printing block 40 is formed from an elastic material. The label 1 on which the printing block 40 is pressed is formed with a thickness dimension (the thickness dimension including the label base section 2, the overcoat layer 3, and the adhesive section 4) of about “50 to 120 μm.” Therefore, when the printing block 40 is pressed into the edge of the label 1, the coated surface of the printing block 40 is elastically deformed, the coated surface comes in contact with the side-surface part of the label 1, and a coating of the overcoat agent 30 is thereby applied to the side-surface part of the label 1.

In FIGS. 7A-C, the printing block 40 is formed on one side of the side-surface part of the label 1 (the side-surface part of the region where the adhesive section 4a is formed) into a shape on which the overcoat agent 30 is printed, but this is merely one example. The printing block 40 may be formed into a shape on which the overcoat agent 30 can be printed over the entire region of the side-surface part of the label 1 in which the adhesive section 4a is formed. For example, the coated surface of the printing block 40 may be formed into a shape (a semicircle when the label 1 is circular) covering the outer peripheral edge of the label 1.

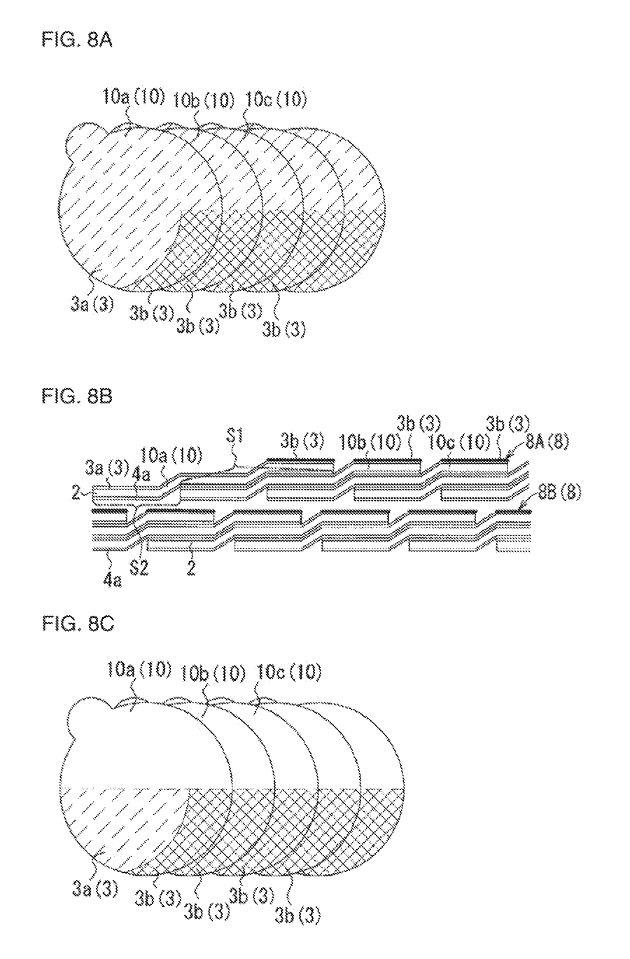

Next, FIGS. 8A-C are used to describe the third embodiment of the present invention. The third embodiment has the configuration of the label roll L of the first and second embodiments described above, with the configuration of the overcoat layer 3 modified, and the configuration is otherwise identical to the first and second embodiments. Therefore, portions different from the first and second embodiments are described in detail below, while descriptions of the same configurations are omitted. In the description of the third embodiment, configurations similar to and equivalent to those of the first and second embodiments use the same symbols for the sake of convenience in the description.

In the third embodiment of the present invention, the overcoat layer 3 is configured having a first overcoat section 3a, and a second overcoat section 3b having less surface roughness (a smoother surface) than the first overcoat section 3a (see FIG. 8A). This first overcoat section 3a is formed by, for example, forming one coating of the overcoat agent on one end side of the label base section 2. The second overcoat section 3b is formed by forming two coatings of the overcoat agent on another end side of the label base section 2.

Specifically, in the third embodiment, the first overcoat section 3a and the second overcoat section 3b are formed on the front surface of the label 10, as shown in FIG. 8A. In this configuration, an adhesive object having the same degree of self-adhesion (a label or another adhesive object) adheres to both the first overcoat section 3a and the second overcoat section 3b, and when this adhered adhesive object is pulled and peeled off, the adhesive object adhered to the first overcoat section 3a has greater frictional force when pulled and resists peeling in comparison with the adhesive object adhered to the second overcoat section 3b. Another option is to form the first overcoat section 3a and the second overcoat section 3b only on the back surface of the surface where the adhesive section 4a is formed, as shown in FIG. 8C.

Next, the band-shaped label set 8 of the third embodiment will be described. Specifically, the band-shaped label set 8 is formed by sequentially causing the first overcoat section 3a formed on the front surface of the second label 10b (the next label following the first label 10a) to adhere to the rear end side region of the adhesive section 4a formed on the back surface of the first label 10a, and then causing the first overcoat section 3a formed on the front surface of the third label 10c (the next label following the second label 10b) to adhere to the rear end side region of the adhesive section 4a formed on the back surface of the second label 10b) (the first overcoat section 3a of each label 10 is disposed in the region where labels 1 of the same layer come in contact (the first contact region)), as shown in FIG. 8(b). The surface area of the region where labels 10 of the same layer adhere to each other (the first contact region) is equal in size with the surface area of the region on the front surface of the label 10 where the first overcoat section 3a is formed. Therefore, when the band-shaped label set 8 is viewed from the front surface, the first overcoat section 3a which constitutes the surface opposite (on the back side) of the surface where the adhesive section 4a is formed and which is part of the first overcoat section 3a of each label 10 (excluding the label 10 at the head) is covered by the adjacent connected label 10 in front.

When the band-shaped label set 8 described above is rolled up into a roll shape around the core 7, labels 10 of an upper and lower layer adhere to each other. Specifically, in each label 10 constituting the band-shaped label set 8, the front-end-side region of the adhesive section 4a formed on the back surface (this region will become a second contact region) overlaps and adheres to the second overcoat section 3b of a lower-layer label 10 disposed one layer lower than this label 10 (the second overcoat section 3b of each label 10 is disposed in the second contact region where labels 1 of an upper and lower layer come in contact with each other), as shown in FIG. 8(b).

Thus, in the third embodiment, two types of overcoat sections (the first overcoat section 3a and the second overcoat section 3b) of different surface roughness are formed on the front surface of the label 10. In the label roll L, adjacent connected labels 10 of the same layer adhere to each other due to the first overcoat section 3a of the front surface of the next label 10 adjacent to a first label 10 overlapping the adhesive section 4a on the back surface of the first label 10. Labels 10 of an upper and lower layer adhere to each other due to the second overcoat section 3b of the front surface of a lower-layer label 10 disposed one layer lower than a first label 10 overlapping the adhesive section 4a of the back surface of the first label 10.

Specifically, in the third embodiment, labels 10 of an upper and lower layer adhere to each other by the overlap with the second overcoat section 3b of a lower surface roughness than the first overcoat section 3a where labels 10 of the same layer overlap with each other. With this configuration, in the label roll L of the third embodiment, the bonding force between adjacent adhered labels 10 of the same layer can be made stronger than the bonding force between labels 10 of an upper and lower layer. Therefore, in the third embodiment, when the tip end of the label roll L is pulled and the labels 10 are drawn out, adhered labels 10 of an upper and lower layer are more readily separated (more readily peeled away) from each other than adjacent connected labels 10 of the same layer. As a result, in the third embodiment, the labels 10 are prevented from being cut off in the middle while the labels 10 are being drawn out from the label roll L.

The relationship between the bonding force between labels 10 of the same layer and the bonding force between labels 10 of an upper and lower layer depends on the sizes of the “first contact region” and the “second contact region,” and the surface roughness of the first overcoat section 3a and the second overcoat section 3b is therefore set as appropriate in consideration of the sizes of the “first contact region” and the “second contact region.”

In the third embodiment, for example, a UV varnish, an aqueous varnish, a silicone release agent, or the like can be used as the overcoat agent forming the first overcoat section 3a and the second overcoat section 3b. The first overcoat section 3a and the second overcoat section 3b may be configured from an overcoat agent of the same substance selected from a UV varnish, an aqueous varnish, and a silicone release agent. The thickness dimension of the overcoat layer 3 (the first overcoat section 3a and the second overcoat section 3b) is formed to, e.g., “1 to 2 μm,” and the thickness dimension of the adhesive section 4 is formed to, e.g., “15 to 20 μm.”

To verify the strength of the “bonding force of a label overlapping and adhering to the first overcoat section 3a” and the “bonding force of a label overlapping and adhering to the second overcoat section 3b,” tests were conducted to measure the peel force and the surface roughness of the first overcoat section 3a and the second overcoat section 3b.

Specifically, a label A comprising an overcoat layer 3 having one coating of silicone (silicone release agent) and a label B comprising an overcoat layer 3 having two coatings of silicone (silicone release agent) were created on the front surface of a base material 2 having a thickness dimension of “60 μm” formed from a coaxially extruded biaxially oriented polypropylene film (BOPP). The surface state, peel performance, and surface roughness of the overcoat layer 3 were inspected in both the labels A, B. The label A was formed by printing (“400-line anilox, coating amount approximately 12 g/m2”) silicone on the front surface of the base material 2. The label B was formed by again printing (400-line anilox, coating amount approximately 6 g/m2) silicone on the front surface of the label A coated once with silicone. The measurement test described above was performed twenty times for each item.

As a result of the inspection, the results shown in Table 1 below were obtained for the surface state and peel performance of the overcoat layers 3 of the labels A, B. The averages of the measured values are shown for the silicone coating amount and the peel force. Cured state and Magic Marker cissing had the same results in all samples.

TABLE 1

| | Silicone | | | | |
|---|---|---|---|---|---|
| | Coating | | Magic | Peel Force (gf/25 mm) | |
| | Amount | Hardened | Marker | 23° C./50% RH) | |
| | (g/m²) | State | Cissing | first day | seventh day |
| Label A (one | 1.3 | Curing | Cissing | 7 | 6 |
| silicone coating) | | good | good | | |
| Label B (two | 1.8 | Curing | Cissing | 6 | 5 |
| silicone coatings) | | good | good | | |

The coating amount of silicone shown in Table 1 is a value calculated using fluorescent X-ray analysis equipment, and the value was “1.3 (g/m2)” for label A and “1.8 (g/m2)” for label B. The cured state was an assessment of the extent of decreased self-adhesiveness of cellophane tape (registered trademark) when the cellophane tape was pressed against the front surfaces (silicone surfaces) of the overcoat layers 3 of the labels A, B, and the cured state was good for both the labels A, B. The Magic Marker cissing was an observation of the cissing condition of ink when lines were drawn (written) with a Magic Marker on the front surfaces (silicone surfaces) of the overcoat layers 3 of the labels A, B, and the ink cissing was good for both the labels A, B. Specifically, the “label A coated once with silicone” and the “label B coated twice with silicone” both had cured and smooth surfaces.

The peel force shown in Table 1 is a value measured by measurement equipment (desktop material tester (STA-1225), made by A&D Company, Ltd.). Specifically, this measurement equipment was used to measure the peel force when the label 10 attached to the front surface (silicone surface) of the overcoat layer 3 of the label A was peeled off at a rate of “0.3 mm/min,” as well as the peel force when the label 10 attached to the front surface (silicone surface) of the overcoat layer 3 of the label B was peeled off at a rate of “03 mm/min.” To measure the peel force, measurements were taken of labels A, B that had been preserved for one day under predetermined conditions, and also of labels A, B that had been preserved for seven days under predetermined conditions. In these measurements, the peel force of peeling off the label 10 attached to the overcoat layer 3 of the label A was confirmed to be greater than the peel force of peeling off the label 10 attached to the overcoat layer 3 of the label B. Furthermore, upon using an electronic microscope on both the labels A, B to observe the front surfaces of the overcoat layers 3, the front surface (silicone surface) of the overcoat layer 3 of the label B was observed to be smoother than the front surface (silicone surface) of the overcoat layer 3 of the label A.

From the results of testing the peel force and surface roughness described above, the label 10 attached to the front surface (silicone surface) of the overcoat layer 3 of the label A was confirmed to be more difficult to peel off than the label 10 attached to the front surface (silicone surface) of the overcoat layer 3 of the label B.

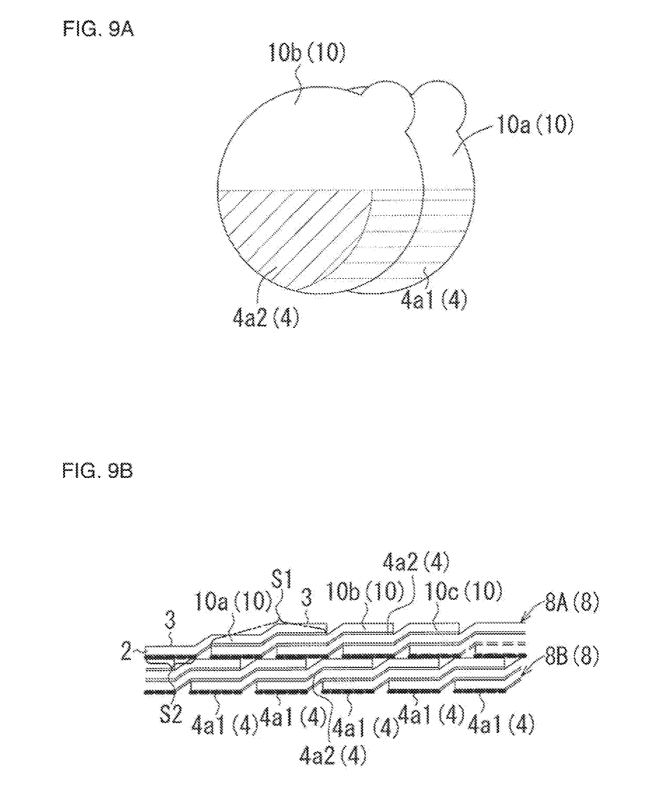

Next, FIGS. 9A-B are used to describe the fourth embodiment of the present invention. FIGS. 9A-B include schematic views depicting the label roll of the fourth embodiment of the present invention, FIG. 9A showing a schematic view as seen from the back surface of a band-shaped label set of the fourth embodiment, and FIG. 9B showing a schematic view showing a cross section of the band-shaped label set of the fourth embodiment. In the fourth embodiment, because the configuration of the adhesive section 4a of the first and second embodiments described above has been modified, the same symbols are used in the description of the fourth embodiment to denote configurations similar or equivalent to those of the first and second embodiments, and descriptions of these configurations are omitted,

In the fourth embodiment, the adhesive section 4a formed on the bottom end region on the back surface of the label base section 2 is formed by being divided into a weak adhesive section 4a1 and a strong adhesive section 4a2 of greater (stronger) self-adhesive force than the weak adhesive section 4a1. Specifically, the adhesive section 4a on the back surface of the label 10 is divided into two regions by the weak adhesive section 4a1 formed on one end side (the front-end-side region) and the strong adhesive section 4a2 formed on the other end side (the other end side region).

The method of forming the weak adhesive section 4a1 and the strong adhesive section 4a2 on the back surface of the label 10 is not particularly limited, but, for example, these sections can be formed as follows. Specifically, first, the bottom end region of the back surface of the label base section 2 is coated with self-adhesive paste by a conventional adhesive layer formation method. Next, varnish or the like is printed in a web pattern on the front-end-side region of the back surface of the label 10 by a multicolor printer. The location where the self-adhesive force is weakened by printing varnish in a web pattern thereby becomes the weak adhesive section 4a1, and the location where varnish is not printed becomes the strong adhesive section 4a2.

The band-shaped label set 8 of the fourth embodiment is formed by sequentially causing the overcoat layer 3 on the front surface of the second label 10b (the next label following the first label 10a) to adhere to the strong adhesive section 4a2 formed on the rear end side region of the back surface of the first label 10a, and causing the overcoat layer 3 formed on the front surface of the third label 10c (the next label following the second label 10b) to adhere to the strong adhesive section 4a2 formed on the rear end side region of the back surface of the second label 10b. The strong adhesive section 4a2 of each label 10 of the label roll L is thereby disposed in a region where labels 10 in the same layer come in contact with each other. When the band-shaped label set 8 is viewed from the back surface, the strong adhesive section 4a2 of the back surface of each label 10 is covered by the next adjacent connected label 10.

When the band-shaped label set 8 is rolled up into a roll shape around the core 7, labels 10 of an upper and lower layer are adhered. Specifically, in each label 10 constituting the band-shaped label set 8, the weak adhesive section 4a1 formed in the front-end-side region of the back surface overlaps and adheres to the overcoat layer 3 of a lower-layer label 10 disposed one layer lower than this label 10. The weak adhesive section 4a1 of the label 10 is thereby disposed in a region where labels 10 of an upper and lower layer come in contact with each other.

Thus, in the fourth embodiment, two types of adhesive sections (the weak adhesive section 4a1 and the strong adhesive section 4a2) having different self-adhesive forces are formed on the back surface of the label 10. In the label roll L, adjacent connected labels 10 of the same layer adhere together by overlapping the overcoat layer 3 of the next label 10 adjacent to this label 10 on the strong adhesive section 4a2 of the back surface of the label 10. Labels 10 of an upper and lower layer adhere together by overlapping the overcoat layer 3 formed on the front surface of a lower-layer label 10 disposed one layer lower than an upper-layer label 10 on the weak adhesive section 4a1 of the back surface of this upper-layer label 10.

Specifically, labels 10 of an upper and lower layer adhere together by overlapping the weak adhesive section 4a1, which has a weaker self-adhesive force than the strong adhesive section 4a2 in which labels 10 of an upper and lower layer overlap and adhere together. Therefore, when the tip end of the label roll L is pulled and labels 10 are drawn out, adhered labels 10 of an upper and lower layer separate more readily (peel away more readily) than labels 10 of the same layer. As a result, in the fourth embodiment, the labels 10 are prevented from being cut off in the middle while the labels 10 are being drawn out from the label roll L.

In the configuration of the label roll L of the fourth embodiment described above, the configuration of the overcoat layer 3 of the third embodiment (a configuration comprising “the first overcoat section 3a and the second overcoat section 3b”) may be formed.

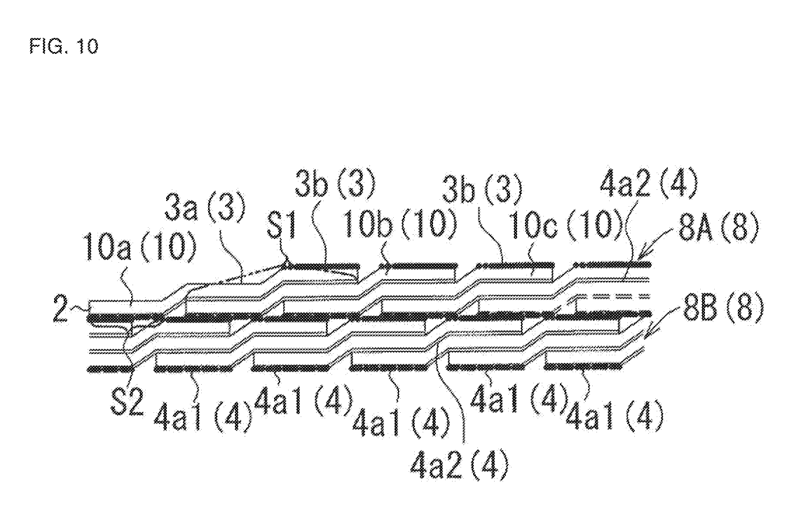

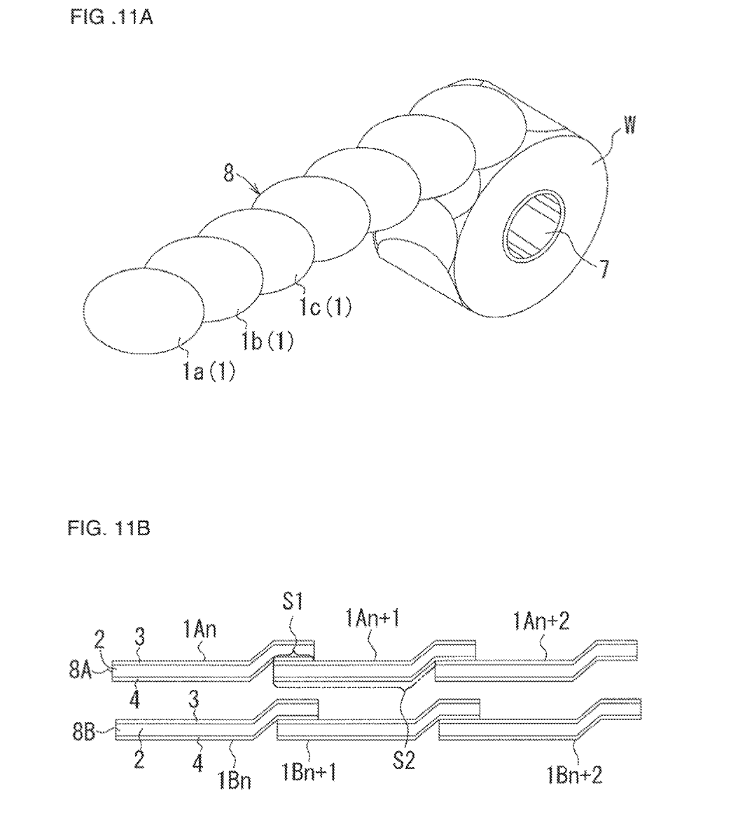

Specifically, in the example shown in FIG. 10, the first overcoat section 3a and the second overcoat section 3b are formed on the front surface of the label base section 2 of each label 10. The weak adhesive section 4a1 and the strong adhesive section 4a2 are also formed in the bottom end region of the back surface of the label base section 2. FIG. 11 includes schematic views showing part of a cross section of a label roil of a modification of the fourth embodiment of the present invention.

The band-shaped label set 8 is formed by sequentially causing the first overcoat section 3a formed on the front end side of the front surface of the second label 10b (the next label following the first label 10a) to adhere to the strong adhesive section 4a2 formed on the rear end side region of the back surface of the first label 10a, and causing the first overcoat section 3a formed on the front end side of the front surface of the third label 10c (the next label following the second label 10b) to adhere to the strong adhesive section 4a2 formed on the rear end side of the back surface of the second label 10b.

When the band-shaped label set 8 described above is rolled up into a roll shape around the core 7, labels 10 of an upper and lower layer adhere to each other. Specifically, in each label 10 constituting the band-shaped label set 8, the weak adhesive section 4a1 formed on the front end of the back surface bottom end region overlaps and adheres to the second overcoat section 3b of a lower-layer label 10 disposed one layer lower than this label 10.

Thus, in the present modification, two types of overcoat sections (the first overcoat section 3a and the second overcoat section 3b) having different surface roughness are formed on the front surface of the label 10. Two types of adhesive sections (the weak adhesive section 4a1 and the strong adhesive section 4a2) having different self-adhesive forces are also formed on the back surface of the label 10. In the label roll L, adjacent connected labels 10 of the same layer adhere to each other by overlapping the first overcoat section 3a of the front surface of the next label 10 adjacent to a first label 10 on the strong adhesive section 4a2 of the back surface of the first label 10. Labels 10 of an upper and lower layer adhere to each other by overlapping the second overcoat section 3b formed on the front surface of a lower-layer label 10 disposed one layer lower than an upper-layer label 10 on the weak adhesive section 4a1 of the back surface of the upper-layer label 10.

Specifically labels 10 of an upper and lower layer adhere to each other by overlapping the weak adhesive section 4a1, which has been treated to weaken the self-adhesive force, on the second overcoat section 3b which has less surface roughness (a smoother front surface) than the first overcoat section 3a where labels 10 of the same layer overlap. Labels 10 of the same layer are also adhered to each other by the overlapping between the first overcoat section 3a which has greater surface roughness (a rougher surface) than the second overcoat section 3b, and the strong adhesive section 4a2 which has not been treated to weaken the self-adhesive force. Therefore, in the present modification, adhered labels 10 of an upper and lower layer separate even more readily (peel off even more readily) in comparison with adjacent adhered labels 10 of the same layer than in the third and fourth embodiments described above. As a result, in the present modification, the labels 10 are prevented from being cut off in the middle while the labels 10 are being drawn out from the label roll L.

The present invention is not limited to the embodiments described above the first through fourth embodiments), and various changes can be made within the range of the scope thereof.

For example, in FIG. 1 described above, the adhesive section 4a is formed in the bottom-end-side region of the label 10, but the invention is ultimately not limited to this example. Nor is the shape of the label 10 particularly limited. For example, the label 10 may be formed into a polygonal shape (a triangle, a square, or another polygon), a star shape, an ellipsoidal shape, or the like.

The following is a list of reference numerals and associated parts as used in this specification and drawings:

| Reference | |
|---|---|
| Numeral | Part |
| L | label roll |
| 1 | label |
| 2 | label base section |
| 3 | overcoat layer |
| 3a | first overcoat section |
| 3b | second overcoat section |
| 4 | adhesive section |
| 4a1 | weak adhesive section |
| 4a2 | strong adhesive section |
| 4b | non-adhesive section |
| 7 | core |
| 8 | band-shaped label set |
| 8A | higher-layer band-shaped label set |
| 8B | lower-layer band-shaped label set |
| 21 | side-surface coat layer |
| 30 | overcoat agent |
| 40 | printing block |
| 50 | UV radiation equipment |
| 60 | roll coater |
| 61 | ink costing application mechanism |

While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention. The scope of the claims should not be limited by the preferred embodiments and examples, but should be given the broadest interpretation consistent with the written description as a whole.

1. A label roll configured by rolling up a band-shaped label set formed by connecting a plurality of labels to be attached to an adherend with part of each label protruding, the label roll comprising:
each of the labels having a label base section and an overcoat layer provided on the front surface of the label base section;
an adhesive section capable of self-adhering to the adherend and a non-adhesive section incapable of self-adhering to the adherend are formed on the back surface of the label base section;
the band-shaped label set being disposed so that the front and back surfaces of a plurality of the labels partially overlap, the labels being connected to each other by causing the overcoat layer of the front surface of the next adjacently disposed label to adhere to a predetermined region of the adhesive section formed on the back surface of each label base section; and
the surface area of the predetermined region of the adhesive section being greater than 50% of the total surface area of the adhesive section formed on the back surface.

2. The label roll according to claim 1, wherein the adjacent labels are connected to each other so that the surface area of the predetermined region of the adhesive section is less than 80% of the total surface area of the adhesive section formed on the back surface.

3. The label roll according to claim 1 wherein the label has a side-surface coat layer formed in a side-surface part of the region where the adhesive section is formed in said label, at least in a location disposed in the adhesive section of the back surface of a front label adjacent and adhered to said label.

4. The label roll according to claim 1, wherein the side-surface coat layer is formed over the entire side-surface part of the region where the adhesive section is formed.

5. The label roll according to claim 3, wherein the side-surface coat layer is formed from the same material as the overcoat layer.

6. The label roll according to claim 1, wherein:
the overcoat layer has first and second overcoat sections having different surface roughness;
the first overcoat section, which has greater surface roughness than the second overcoat section, is formed in a first contact region where labels of the same layer come in contact with each other; and
the second overcoat section is formed in a second contact region where labels of an upper and lower layer come in contact with each other.

7. The label roll according to claim 6, wherein:
the first and second overcoat sections are configured from an overcoat agent of the same material selected from a UV varnish, an aqueous varnish, and a silicone release agent;
the first overcoat section is formed from a single coating of the overcoat agent; and
the second overcoat section is formed from two coatings of the overcoat agent.
